(19) United States
(12) Patent Application Publication
(10) Pub. No.: US 2005/0173333 A1
(43) Pub. Date: Aug. 11, 2005

(54) Membrane devices and device components

(76) Inventors: Steven D Kloos, Chanhassen, MN (US); Philip Rolchigo, Pittstown, NJ (US); Chia Kung, Eden Prairie, MN (US)

Correspondence Address: SCHWEGMAN, LUNDBERG, WOESSNER & KLUTH, P.A.;GE OSMONICS, P.O. BOX 2938, MINNEAPOLIS, MN, 55402, US

(21) Appl. No.: 10/516,579

(22) PCT Filed: Jun. 4, 2003
(86) PCT No.: PCT/US03/17527

Related U.S. Application Data
(60) Provisional application No. 60/386,032, filed on Jun. 4, 2002.
(60) Provisional application No. 60/386,032, filed on Jun. 4, 2002.

(51) Int. Cl. B01D 61/00

(52) U.S. Cl. 210/488; 210/321.83

(57) ABSTRACT

A membrane device including a first membrane sheet and a second membrane sheet comprised of either two separate sheets or one sheet folded upon itself separated by a permeate carrier. The membrane device utilizes permeate carrier materials that have a lower resistance to flow and therefore provide improved flux and reduced salt passage.

### RELATED APPLICATION

This application claims the benefit of U.S. Provisional Application, Ser. No. 60/386,032, filed Jun. 4, 2002, under 35 USC 119(e), which is incorporated herein by reference.

### BACKGROUND

Reverse osmosis (RO), nanofiltration (NF), and ultrafiltraiton (UF) are examples of pressure-driven membranes processes. Membranes are typically named after the processes in which they are used.

The most common configuration of RO, NF, and UF membranes is in flat sheet form. The flat sheet is often made in a continuous process, and is often between 4 mils and 20 mils thick and between 6″ and 70″ wide. The flat sheet membrane may be used in a variety of configurations, including in a pressure cell, in a plate and frame system, and in a spiral wound membrane element. The most common form of device that utilizes flatsheet RO, NF, or UF membrane is the spiral wound element. A spiral wound element is comprised of a leaf, or a combination of leaves, wound around a central tube with a feed spacer material. Spiral wound membrane elements are described in Bray (U.S. Pat. No. 3,417,870) and Lien (U.S. Pat. No. 4,802,982), both of which are incorporated herein by reference in their entireties.

As described in the referenced literature, the “leaf” is a combination of two membranes with a permeate carrier placed between the membranes. The region between the two membrane sheets is called the permeate channel. The leaf package is sealed to separate the permeate channel, with part of the permeate channel unsealed to allow for removal of the permeate fluid. For instance, in a spiral-wound membrane element, three sides of the leaf are typically sealed, while the fourth side of the leaf is typically connected to a permeate tube. The leaf length is defined as the longest straight-line distance of permeate flow to the permeate collection channel.

Spiral-wound membrane elements are relatively inexpensive to produce. A single-leaf membrane element is much simpler and less costly to produce than membrane elements that contain multiple leaves. Each extra leaf used in a membrane-element reduces the maximum amount of area that can be placed in an element having specific dimensions because the additional leaves require additional glue lines and also because the typical fold of a leaf at the permeate tube is often sealed and can account for lost active membrane area. Further, additional leaves in a membrane element lead to a higher likelihood of element failure because of improperly placed leaves during element fabrication and also because higher amounts of leaves make it more difficult to produce a uniformly round element.

Industrial reverse osmosis applications typically operate at relatively high pressures. For example, seawater desalination typically requires operating pressures of 600 to 900 psi. The high operating pressure is required due to the ˜350 psi osmotic pressure of ocean water and to the relatively low permeability of “seawater RO” membranes. Typical “brackish water” RO membranes operate with between 200 to 300 psi of applied pressure. In the past few years, certain membrane companies have developed “low pressure” reverse osmosis membranes that yield about 70% greater permeability than typical “brackish water” RO membranes. Low-pressure RO membranes typically operate at 120-180 psi. An example of such a membrane is the Desal AK membrane manufactured by Osmonics, Inc.

Home reverse osmosis (HRO) applications typically are driven by the pressure in the water piping in a home. In the US, this pressure is typically around 60 psi. In other countries, this pressure can be as low as around 20 psi. In some cases, a pressure pump is used to increase the driving pressure in home reverse osmosis, though the maximum driving pressure is often no greater than 75 psi-125 psi. The typical home reverse osmosis membrane element is 1.6″-1.9″ in diameter and 12″ long (10″ of membrane with one inch of permeate tube protruding from each end). Consequently, the amount of membrane that can be placed in a typical home reverse osmosis membrane element is a function of the thickness of the materials used in the element construction, including the permeate carrier.

Recently, an ultra high flux RO membrane that provides a water permeability that is nearly three times as great as the permeability of brackish water RO membranes and provides about 75% greater permeability than “low pressure” RO membranes has been prepared. The ultra high flux RO membrane, termed the AN membrane, is disclosed in U.S. Provisional Patent Application Ser. No. 60/360,696, filed Mar. 1, 2002, and PCT application No. PCT/US03/06587, filed Mar. 3, 2003, both of which are incorporated herein by reference in their entirety. Because of its extremely high pure water permeability, the AN membrane will most likely be operated in the pressure range of 40 to 80 psi.

The permeate carrier is an important part of the spiral-wound membrane element. Its function is to provide a channel for the permeate to flow through on its way to the permeate tube. The permeate carrier must be able to effectively keep the adjacent membranes from intruding into the permeate channel and must provide a relatively low resistance to permeate flow. Any pressure build-up in the permeate channel will cause an equal reduction in the net driving force of the membrane process. The net driving force to the membrane is defined as the pressure in the feed channel minus the osmotic pressure and minus the permeate pressure.

In most industrial and home reverse osmosis applications, the typical amount of average pressure loss in the permeate channel is low relative to the net driving pressure. Consequently, the pressure loss in the permeate channel does not overly affect the overall output of the membrane element. However, when a membrane element is produced that uses the newly developed high flux membranes, the resulting high membrane flux rates leads to a significant pressure loss in the permeate channel can have a major impact on the total element output. The table below describes the impact of using a high flux membrane in a standard membrane element configuration.

| | Average | Average | Average | % Flux |
|---|---|---|---|---|
| | Feed | Osmotic | Permeate | Loss Due |
| | Pressure | Pressure | Pressure | to Permeate |
| Example Process | (psi) | (psi) | (psi) | Pressure |
| Seawater RO | 700 | 350 | 10 | 3% |
| Brackish Water RO | 250 | 15 | 10 | 4% |
| Low Energy RO | 150 | 15 | 10 | 7% |
| Home RO - Low Flux | 60 | 6 | 2 | 4% |
| Membrane | | | | |
| Home RO - High Flux | 60 | 6 | 16 | 30% |
| Membrane | | | | |
| Industrial RO - High Flux | 70 | 10 | 10 | 17% |
| Membrane | | | | |

The leaf length in Home RO is typically longer than in Industrial RO, as Home RO elements are typically made in a single-leaf design due to the significant cost pressures that almost prohibit the manufacture of a low-cost multi-leaf element for Home RO applications. It is not practical using current methods to make an Industrial RO element in a single leaf design as the required leaf length for a typical 8″ diameter element would be about 60 feet. The longer leaf length in Home RO elements relative to Industrial RO elements is the cause for the higher permeate pressure loss in the Home RO element when using the high flux membrane (such as the AN membrane).

The salt rejecting ability of RO membranes is directly related to the driving pressure, with higher driving pressures leading to higher salt rejection. Therefore, the permeate side pressure loss does not only reduce membrane flux but also increases the salt passage through the membrane.

### SUMMARY

The use of high flux membranes, coupled with low-pressure operation, has led to the problem of the permeate side pressure drop severely limiting the flow output of the membrane device and reducing the salt rejecting ability of the membrane. The present system utilizes new permeate carrier materials that have a lower resistance to flow and therefore provide improved element flux and reduced salt passage. Further, because the newly developed high flux membranes can operate at low pressures, the permeate carrier does not need to maintain the integrity of the permeate channel at the high pressures required by current reverse osmosis membranes. The low-pressure operation allows for the use of permeate carrier materials that would not have been otherwise useful for traditional, higher-pressure operation.

### BRIEF DESCRIPTION OF DRAWINGS

FIG. 1 shows a cross-section of a membrane device according to one embodiment.

FIG. 2 shows a schematic representation of a home RO system according to one embodiment.

FIG. 3 shows a single-leaf spiral wound membrane element according to one embodiment.

FIG. 4 shows a multi-leaf spiral wound membrane element according to one embodiment.

FIG. 5 shows a two-leaf spiral wound element according to one embodiment.

### DETAILED DESCRIPTION

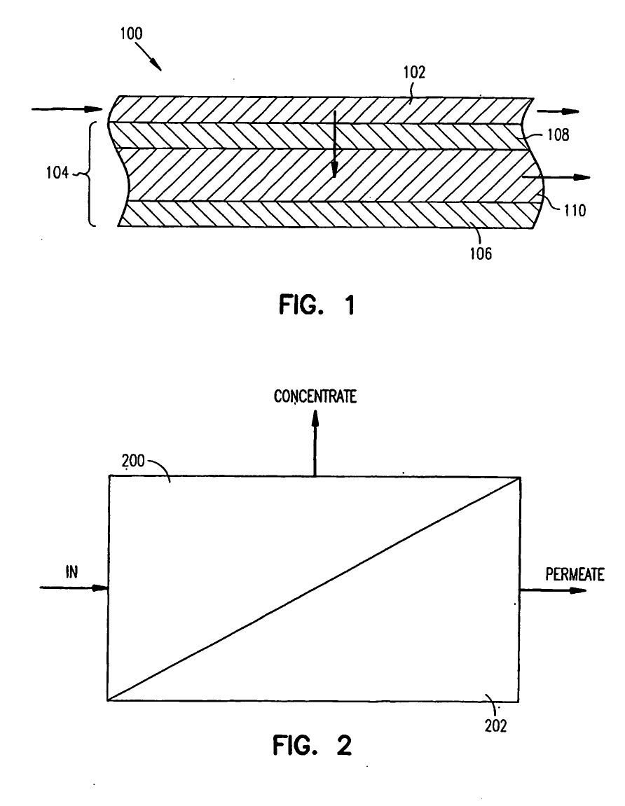

FIG. 1 shows a schematic cross-section of a portion of a membrane device 100 according to one embodiment. Membrane device 100 includes a sheet 102 to supply feed solution and a leaf structure 104 which includes a pair of membranes 106 and 108 sandwiching a permeate carrier 110. The pair of membranes can be two separate membranes or a single membrane folded upon itself. Flow of a solution is indicated by the arrows, with solution entering the feed sheet 102, permeate going through membrane 108 into permeate carrier 110 and unfiltered concentrate continuing through sheet 108. Membrane device 100 can be used in a spiral wound configuration, a plate and frame configuration, and other similar configurations.

Element Efficiency

The element efficiency, β, is roughly the net driving pressure divided by the sum of the net driving pressure plus the pressure in the permeate channel. The lower net driving pressure is due to pressure drop resulting from flow through the permeate channel and is influenced by the nature of the permeate carrier. β can be derived from elementary fluid dynamics, and is equal to

$$β = \frac{Tanh ( L \sqrt{2 A * {10}^{5} * H )}}{L \sqrt{2 A * {10}^{5} * H}}$$

Where:

A is the membrane A-value, representing membrane permeability in units of:
10⁻⁵*permeate flow in grams/(membrane area in cm²*time in seconds*net driving pressure in atmospheres)

L is the leaf length (defined as the longest straight-line distance of permeate flow to the permeate collection channel).

H represents the flow resistance of the permeate carrier, in units of (seconds*atmospheres)/gram

Using these expressions it is clear that to obtain high element efficiencies, L, A, and H should all be minimized. However, as many uses would benefit from the maximum flow through an element, the A value is often desired to be high. Further, as long leafs are often less expensive to use in elements and allow more area to be fit into an element, it is also desirable to increase L. Thus in order to maximize the efficiency of an element it is desirable to minimize the value of H.

H can be derived from fluid mechanics and is expressed below.

$$H = \frac{{f}_{l} 4 μ}{{d}_{h}^{3}}$$

where f₁ is a friction factor
μ is the viscosity
dₕ is the hydraulic diameter of the permeate channel

A useful overview of element efficiency and the P term can be found in Lien U.S. Pat. No. 4,802,982.

Permeate Carrier Design

For a given feed solution where the viscosity is fixed, the H value of a permeate carrier is dependent on the friction factor and the thickness of the permeate carrier. Thus to minimize the H value of a permeate carrier its thickness can be increased. However, as elements are often designed to fit within pressure vessels of fixed diameter, increased permeate carrier thickness necessitates the use of less membrane area As less membrane area reduces the element flow, other strategies to lower the H value are desirable.

The friction factor reflects pressure drop from flow through the permeate carrier due to several factors, including: friction with the permeate carrier surfaces, turbulence promoted by the channel geometry, and other permeate carrier design factors that are independent of thickness. Improved H values obtained through decreased friction factors allows thinner and more efficient permeate carriers to be used. Thus permeate carriers with lower friction factors would be highly useful.

The friction factor of a permeate carrier can most easily be decreased by increasing the size of the channels it contains. However, in addition to transporting permeated fluid, the permeate carrier needs to support the membrane against the hydraulic pressure used to drive the separation. If the permeate carrier is unable to properly support the membranes, the permeate channel thickness will be reduced, leading to higher permeate channel pressure drop and also may lead to element deformation. In the past, low membrane A values (<20) have required the use of high net driving pressures (>100 psi) to obtain reasonable fluxes and as a result, relatively dense permeate channels were required to support the permeate carrier from compaction. These dense channels have a high resistance to flow and thus give high H values. However, because the applied pressure was significantly high relative to the pressure build-up in the permeate channel, the membrane elements yielded a relatively high β term.

New Permeate Carriers

With new higher flux membranes, use of existing permeate carriers proved difficult as poor efficiencies were obtained. However, as lower operating pressures are used with these membranes it was surprisingly found that new types of permeate carriers could now be used which had relatively wide channels. These provided low H values while still supporting the permeate channel at the pressures used.

The permeate carriers effective for use in these elements are unique by virtue of their low H value for a given thickness as illustrated below. The permeate carriers are also unique in that they provide low resistance while being thin, yet are still able to support the permeate channel from significant intrusion by the membranes.

[image]

Use of the new permeate carriers were found to enable several new element constructions which are described below.

The above plot represents improved permeate carriers according to some embodiments. The improved permeate carriers of this invention are those which are able to provide high efficiency elements made from highly permeable reverse osmosis membranes having longer leaf lengths.

Other examples of permeate carries may give similar beneficial results. For example, some embodiments of membrane devices can include a permeate carrier having an H-value of 0.030 atm-sec/gm or less and a thickness of approximately 0.025 inches or less, a permeate carrier having an H-value of 0.070 atm-sec/gm or less and a thickness of approximately 0.015 inches or less, a permeate carrier having an H-value of 0.10 atm-sec/gm or less and a thickness of approximately 0.013 inches or less, and a permeate carrier having an H-value of 0.05 atm-sec/gm or less and a thickness of approximately 0.021 inches or less.

Membrane devices made with such permeate carriers give improved performance in RO applications where a substantial amount of salt is retained by a membrane. Herein, a substantial amount of salt retained is when a membrane device is capable of at least 50% MgSO₄ rejection of 500 ppm MgSO₄ in DI water at 65 psi applied pressure at 10 cm/s average feed channel cross-flow velocity at 77 degrees F.

| Perm | | | | | | | | HRO Element | | | |
|---|---|---|---|---|---|---|---|---|---|---|---|
| Carrier | | | Active | | | Membrane | | Model Prediction | | | |
| Thickness | | | Area | Leaf Length | | Measured | | Flow | A- | Rej. | Efficiency |
| (in) | Manufacturer | Style | (ft\hat{ }2) | (ft) | H-Value | A-value | Rej. (%) | (GPD) | value | (%) | or % β |
| 0.01300 | Deistar | 75-3722 | 6.40 | 4.25 | 0.04 | 35.0 | 97.5% | 160.6 | 29.0 | 96.3% | 86.8% |
| 0.01300 | Deistar | 75-3718 | 6.40 | 4.25 | 0.05 | 35.0 | 97.5% | 155.7 | 28.1 | 96.2% | 84.1% |
| 0.01000 | Deistar | S-1886 | 6.40 | 4.25 | 0.18 | 35.0 | 97.5% | 114.6 | 20.7 | 94.9% | 61.7% |
| 0.01550 | Deistar | 75-4410 | 6.40 | 4.25 | 0.05 | 35.0 | 97.5% | 155.7 | 28.1 | 96.2% | 84.1% |
| 0.07000 | Deistar | S-1888 | 6.40 | 4.25 | 0.80 | 35.0 | 97.5% | 60.9 | 11.0 | 91.2% | 32.5% |
| 0.02050 | Deistar | S-1111 | 6.40 | 4.25 | 0.05 | 35.0 | 97.5% | 155.7 | 28.1 | 96.2% | 84.1% |
| 0.00675 | Deistar | S-2367 | 6.40 | 4.25 | 1.44 | 35.0 | 97.5% | 45.8 | 8.3 | 88.7% | 24.3% |
| 0.02000 | Hornwood | HW 1414 | 6.40 | 4.25 | 0.03 | 35.0 | 97.5% | 165.8 | 29.9 | 96.4% | 89.7% |
| 0.01200 | Hornwood | HW1613 | 6.40 | 4.25 | 0.22 | 35.0 | 97.5% | 106.8 | 19.3 | 94.6% | 57.4% |

The above table shows a few examples of improved permeate carriers and their modeled performance in an HRO style element. The model was developed to predict element flow and rejection by accounting for the permeate side pressure loss and the effect it has on net driving pressure in addition to the build-up of salts near the membrane due to concentration polarization. The net driving pressure affects both membrane flux and membrane salt rejection, with increased net driving pressure leading to higher membrane flux and higher salt rejection (or decreased salt passage). The model iterates the overall membrane flux as a function of both the element efficiency and the concentration polarization. The determination of the amount of salt at the membrane surface is used with the measured flat sheet membrane rejection to calculate the salt passage through the membrane, which is then used to calculate osmotic pressure. The osmotic pressure decreases the driving pressure and flux and thus increases the element efficiency. This iteration is repeated until it converges on a constant predicted performance. Thus, the developed model provides a tool for probing the effects of feed pressure, salt concentration, membrane rejection, permeate carrier H-value, permeate carrier length, and membrane permeability on membrane element performance.

As one can see, assuming the same element active area and membrane performance, one can change the permeate carrier and very different results will appear. For example using the Delstar 75-3722 permeate carrier as compared to Delstar S-2367 permeate carrier, the modeled element efficiencies are 86.8% vs. 24.3% respectively. This drop in efficiency can be directly seen in the element performance. The flow rates changed from 160.6 to 45.8 GPD, at the same time the salt rejection went from 96.3% to 88.7%.

Examples of Element Efficiencies, Element Flow, and Salt Passage Using Different Permeate Spacer Materials

In the following nine experiments three different permeate spacers with different H-values were used to construct a HRO style element. In all cases except experiments 2 and 5 the element dimensions were 1.9″ diameter×11.75″ long. The actual “scroll” of the element, or the length the membrane along the permeate tube, is 10.4″ with a 0.812″ protrusion at the o-ring end and 0.59″ at the brine seal end. In experiments 2 and 5 the dimensions were 1.8″ diameter and 11.75″ long, with a scroll of 10.0″. Element permeate flow and rejection were determined at 65 psig feed pressure and temperature corrected to 77° F. The feed source for experiments 1-5 was a synthetic blend of 500 ppm NaCl in DI water and experiments 4-9 were tested on Minnetonka tap water (˜650 μS). The flat sheet membrane samples were tested at 100 psig and 77° F. using a synthetic blend of 500 ppm NaCl in DI water and were tested with a fluid flow Reynolds number of greater than 2500.

| | | | | | | | | Membrane | |
|---|---|---|---|---|---|---|---|---|---|
| | Perm Carrier | | | Element | Active | Leaf | | Measured | |
| Experiment | Thickness (in) | Manufacturer | Style | Diameter (in) | Area (ft\hat{ }2) | Length (ft) | H-Value | A-value | Rej (%) |
| 1 | 0.010 | Hornwood | HW1851 | 1.90 | 7.10 | 4.70 | 0.13 | 27.8 | 94.8% |
| 2 | 0.010 | Hornwood | HW1851 | 1.80 | 5.30 | 3.75 | 0.13 | 27.8 | 94.8% |
| 3 | 0.010 | Hornwood | HW1851 | 1.90 | 7.10 | 4.70 | 0.13 | 37.9 | 84.4% |
| 4 | 0.010 | Hornwood | HW1851 | 1.90 | 7.10 | 4.70 | 0.13 | 17.6 | 97.1% |
| 5 | 0.010 | Hornwood | HW1851 | 1.80 | 5.30 | 3.75 | 0.13 | 17.6 | 97.1% |
| 6 | 0.020 | Deistar | S-1111 | 1.90 | 4.60 | 3.08 | 0.03 | 30.1 | 97.4% |
| 7 | 0.020 | Deistar | S-1111 | 1.90 | 4.60 | 3.08 | 0.03 | 37.5 | 88.5% |
| 8 | 0.013 | Deistar | 75-3719 | 1.90 | 6.40 | 4.25 | 0.05 | 30.1 | 97.4% |
| 9 | 0.013 | Deistar | 75-3719 | 1.90 | 6.40 | 4.25 | 0.05 | 45.0 | 88.5% |

| HRO Element | |
|---|---|
| Measured | Model Prediction |

| | | | | Efficiency | Flow | | Rej. | Efficiency |
|---|---|---|---|---|---|---|---|---|
| Experiment | Flow (GPD) | A-value | Rej. (%) | or % β | (GPD) | A-value | (%) | or % β |
| 1 | 124.9 | 20.3 | 92.6% | 73.1% | 119.9 | 19.5 | 91.6% | 68.2% |
| 2 | 113.5 | 24.7 | 93.0% | 89.0% | 101.7 | 22.2 | 92.4% | 75.3% |
| 3 | 164.5 | 26.8 | 50.0% | 70.6% | 148.6 | 24.2 | 64.5% | 62.2% |
| 4 | 93.4 | 15.2 | 95.2% | 86.3% | 79.7 | 13.0 | 90.4% | 77.1% |
| 5 | 78.7 | 17.2 | 95.1% | 97.4% | 65.1 | 14.2 | 91.0% | 83.8% |
| 6 | 121.6 | 30.5 | 94.8% | 101.5% | 112.1 | 28.1 | 94.0% | 95.6% |
| 7 | 146.2 | 36.7 | 96.5% | 97.9% | 148.0 | 37.2 | 76.2% | 94.3% |
| 8 | 163.3 | 29.5 | 94.3% | 97.9% | 161.1 | 29.1 | 94.3% | 81.6% |
| 9 | 233.3 | 42.1 | 85.9% | 93.6% | 156.2 | 28.2 | 77.4% | 78.3% |

Experiments 1 through 5 utilized a standard 0.010″ thick material manufactured by Hornwood with a measured H-value of 0.132. This coated woven polyester material has 34 channels per inch (also termed “wale”) and is widely used as a permeate carrier in elements made for HRO application as well as commercial/industrial applications of various pressures. In experiments 1 and 3, high flux AN membrane was used at a maximized leaf length of 4.7′ to achieve the full diameter of 1.9″. Results of experiments 1 and 3 show element efficiencies (β) to be 73.1% and 70.6% respectively. Experiment 3 had a flat sheet membrane A-Value of 37.9 and due to the poor element β, the observed element A-value was only 26.8 and therefore only achieving a permeate flow rate of 164.5 GPD (Gallons Per Day). By observed A-value it is meant the membrane A-value neglecting the effect of permeate side pressure loss in the determination of net driving pressure. If the element had a β of 1.00, the resulting flow rate is predicted to be 233.0 gallons per day. The low element efficiency did not only effect the element permeate flow rate but also membrane salt rejection. The low β caused a drop in net driving pressure due to the permeate restriction which caused the element to only have a 50.0% rejection when the flat sheet membrane provided a rejection of 84.4%. Experiments 2 and 4 show the same trend in β, and as a result lower permeate flow rate and lower membrane salt rejection. It was not until the membrane A-value and leaf length was dropped did we see element β in the >95% range using the same Hornwood 0.010″ thick 34 wale permeate carrier as used in experiment 5. “Low energy” membrane (A=17.6) used with a leaf length of 3.75′ in experiment 5 gave a β of 0.975.

Experiment 6 and 7 use a 0.020″ thick Naltex® S-1111 material with an H-value of 0.026 as the permeate carrier along with high flux AN membrane. This Naltex® spacer has a much lower H-value than the previous examples from Hornwood. Due to the increased permeate carrier thickness; the membrane leaf length was limited to 3.08′ in order to achieve the fixed diameter of 1.9″. β Values for these two experiments were well above the >95% range, close to the 100% mark, but due to the decrease in leaf length this particular membrane element had limited output due to the low amount of active area. It should be noted that the membrane rejection was relatively high in these experiments, due to the consistently high net driving pressure along the entire leaf length.

In experiments 8 and 9 a new 0.013″ thick Naltex® 75-3719 material with an H-value of approximately 0.05 was used. The H value was determined by analysis of element performance. This Naltex® spacer, which was designed for use as a feed spacer and which had not been used previously as a permeate carrier, provides the characteristics we discovered were necessary for an optimized low pressure HRO, high permeate flow, high rejection element. This material has a less obstructed flow pathway. In the past this spacer was not given consideration as a permeate carrier for reverse osmosis applications due to its relatively open structure which would not support high-pressure operation. With this thin material used as the permeate carrier, an element with a leaf length of 4.25′ was manufactured to a diameter of 1.9″, allowing for much greater active membrane area than possible in experiments 6 and 7. Experiment 8 shows that that this element design provides high element efficiency and allows for high membrane rejection. Experiment 9 shows a remarkable permeate flow rate of 233.3 GPD and a relatively high 85.9% salt rejection was achieved using a membrane having a high A-value and 88.5% flat sheet membrane rejection.

It is clear from these experiments that the use of low resistance permeate carriers allows for higher membrane output and higher salt retention. Further, the experiments show that the use of thin, low resistance permeate carriers allows for even higher membrane output and higher salt retention. Also, the use of thin, low resistance permeate carriers allows for the production of high salt rejection membrane elements that use shorter leafs, resulting in cost savings due to the use of less membrane and other components, when compared to elements that provide similar flow output but are made from higher resistance permeate carriers.

The permeate carrier can be made of any suitable material having the flow resistance characteristics (e.g. H values) described herein, provided the material is capable of suitably supporting the permeate channel under operating conditions. For example, the permeate carrier can be made of metal (e.g. stainless steel), ceramic, or an organic polymer (e.g. nylons, polypropylenes, polyesters, or coated polyesters). Suitable materials have previously been utilized in a variety of applications, for example as feed spacers in spiral-wound reverse osmosis elements (feed spacers for reverse osmosis are typically 17 mils thick or greater, with some exceptions allowing for feed spacers as thin as 13 mils to be used), as supports for pleated filters (6-mil to about 20-mil thick spacers are commonly used in these applications), as covering for depth filtration media to prevent the media from migrating (6-mil to about 20-mil thick spacers are commonly used in these applications), as HVAC screens in the automotive industry, or as tank liners. Accordingly, such materials are commercially available. Additionally, materials having the desired thickness and permeability properties can be prepared for use in the materials and methods of the invention. One specific material that can be employed as a permeate carrier is the polypropylene spacer material sold under the name Naltex 75-3719, as described in Experiments 8 and 9 herein.

Efficiency Improvement

| | | Calculated | | | | |
|---|---|---|---|---|---|---|
| | | Permeate | | Observed | Measured | Measured |
| | Leaf | Carrier | Membrane | Element | Flux | NaCl |
| Permeate Carrier | Length (in) | H-Value | A-value | Efficiency | (gfd) | Passage |
| Hornwood 1851 | 37.1 | 0.132 | 53 | 72.4% | 36.9 | 5.5% |
| Naltex 75-3719 | 34.3 | 0.042 | 55 | 86.0% | 46.1 | 4.6% |

Tested at the same time under the same conditions:

| | |
|---|---|
| Temperature | 77 F. |
| Inlet Pressure | 76 psi |
| Outlet Pressure | 71 psi |
| NaCl Feed Concentration | 560 ppm |
| Crossflow velocity | 19 cm/s |

Each membrane element contined 5 leafs
Each membrane element was approximately 4″ in diameter and 40″ in total length

The above table provides an example of the benefits of the improved permeate carrier over a commonly used permeate carrier in reverse osmosis applications. The benefit is accentuated by the use of an extremely permeable reverse osmosis membrane having an A-value of 53-55. As the table shows, the uses of the standard permeate carrier yields an element having relatively low efficiency and consequently relatively modest flux and higher than expected salt passage. The elements made with the new permeate carrier yield a commercially acceptable efficiency, which results in approximately 20% higher flux and also in lower salt passage. The test was conducted using similarly constructed, 5-leaf membrane elements.

Use of New Permeate Carriers to Prepare Novel Element Designs

Longer Leafs

Using the expression for beta, an existing permeate carrier with an H value of 0.075 and the new permeate carrier with an H value of 0.03, and a membrane with an A value of 20 (seen in many commercial “low energy” reverse osmosis membranes), the following data can be obtained. This data describes the efficiency of elements prepared with leaves of various lengths.

| Leaf | Efficiency | Efficiency | Flow increase and |
|---|---|---|---|
| Length (ft) | old | new | Passage decrease |
| 1 | 99% | 100% | 1% |
| 5 | 82% | 97% | 19% |
| 10 | 56% | 89% | 60% |
| 15 | 39% | 79% | 101% |
| 20 | 30% | 69% | 130% |

As can be seen, the benefit of the new permeate carrier grows as the leaf length increases. Use of these longer leaves enable fewer leaves to be used in an element, while maintaining the same element efficiency, resulting in manufacturing cost savings and an increase in membrane active area (due to the fewer glue lines needed).

In addition, when reverse osmosis membranes are used, the rate of solute (e.g. salt) transport is unaffected by the increased efficiency so the element will exhibit lower salt passage. Thus these new permeate carriers increase both the flow rate and rejection of an element.

The improvements seen with the new permeate carrier becomes even more pronounced as the membrane A value increases as seen below for a membrane with an A value of 30, the value of the new AN membrane. The H values used are the same as above.

| | | | Flow increase and |
|---|---|---|---|
| Leaf | Efficiency | Efficiency | Relative Passage |
| Length (ft) | old | new | reduction |
| 1 | 99% | 100% | 1% |
| 5 | 75% | 96% | 27% |
| 10 | 47% | 85% | 79% |
| 15 | 32% | 72% | 122% |
| 20 | 24% | 61% | 148% |

As a result of this new permeate carrier, new longer leaf element constructions are now allowed which maintain the overall element efficiency. These longer leaves can be used in new element construction using either a single leaf or multiple leaves. Known elements rarely use leaves longer than 3 feet, and almost never longer than 5 feet to maintain the efficiency higher than about 85%. Use of the new permeate carrier enables new element constructions with leaves between 5 feet and 12 feet while maintaining the same 85% efficiency. Without the discovery of these new permeate carriers such element constructions, though useful, would not have been thought possible.

As even longer leaves would often be preferable for cost reasons, new elements using leaves of up to 20 feet are also now enabled by this permeate carrier which maintain relatively good efficiencies (up to ˜60%). Also, as the new permeate carriers are not overly thick, they do not significantly subtract from the amount of membrane being used in a fixed dimension membrane element and they do they not significantly increase the membrane element dimensions when used in an element having a specified amount of total active area.

Number of Leaves

Use of fewer leaves is beneficial as it decreases the cost of an element and also allows more membrane area to be within a given diameter. This effect is most pronounced when the number of leaves can be limited to one, allowing for the use of efficient manufacturing techniques not possible when producing a multi-leaf element. This effect is illustrated below for a series of elements that all have an outside diameter of 1.9 inches or approximately 2.0 inches or less, (this outer diameter is needed to fit within 2 inch inner diameter pipes which are commonly used as pressure vessels in HRO applications). The table below illustrates these new element constructions. A membrane with an A value of 30, and H values of 0.075 and 0.01 for the representative old and new permeate carriers respectively are used to calculate this information. The flow increase and passage decrease are relative to the old single leaf element. Note that the permeate carrier thickness is 13 mils in both cases.

| | | | | | Salt |
|---|---|---|---|---|---|
| Permeate | Number of | Leaf | | Flow | Passage |
| carrier | leaves | length | Efficiency | Increase | decrease |
| old | 1 | 4.6 | 78% | 0% | 0% |
| old | 2 | 2.1 | 94% | 10% | 21% |
| new | 1 | 4.6 | 96% | 23% | 23% |
| new | 2 | 2.1 | 99% | 16% | 27% |

From this it can be seen that use of the new permeate carrier not only eliminates the need for multiple leaves, it also results in a higher element flow than the known multiple leaf design.

In addition, this table illustrates a new multiple leaf design that was surprisingly found to exhibit improved passage relative to known multiple leaf design. Similar benefits are observed for other common element diameters such as 2.5, 4 and 8 inches. Thus new single and multiple leaf elements are found exhibiting better performance through the use of the new permeate carrier.

In various embodiments, leaf structures and membrane elements can be produced having combinations of two or more of the following values. H-value can be greater than about 0.1, about 0.1, about 0.07, about 0.02, or less than 0.02. H-value can range from about 0.02 to about 0.07, and from 0.07 to about 0.1. Some examples use an H-value of approximately 0.024 or less; some have an H-value of 0.015 or less. Some embodiments use an H-value of 0.060 or less.

Some use an H-value of 0.045 or less, 0.10 or less, 0.07 or less, 0.05 or less, and 0.03 or less. Some use an H-value of 0.025 or less. The permeate carrier thickness be less than about 0.008 inches, about 0.008 inches, about 0.015 inches, about 0.025 inches, or greater than 0.025 inches. In some examples, thicknesses can range from between 0.008 to 0.025 inches. In some embodiments, the thickness can be 0.025 inches or less, 0.015 inches or less, 0.013 inches or less, or 0.021 inches or less. In various examples, the membrane A-value can range from less than 15, from 15 to 25, from 25 to 40, from 15 to 30, from 25 to 35, from 30 to 40, from 35 to 60, from about 40 to 60; some examples are about 15, about 25, about 35, about 40, about 50 and about 60; some examples have an A-value of about 15 or greater, about 25 or greater, about 35 or greater, about 40 or greater, about 50 or greater, and about 60 or greater. The leaf length can range from less than 3 feet, from about 3 feet to 5 feet, from 5 feet to 15 feet. Some examples are about 3 feet, about 5 feet and about 15 feet. The β value can range from less than 0.80, from 0.80 to 0.90, from 0.90 to 0.97. Some examples have a β value of about 0.80, about 0.90, and about 0.97. Moreover, since many of these factors affect each other, the values can range higher or lower than those noted above if other parameters are also varied.

Also, since a leaf in a spiral-wound membrane element is similar to a membrane-permeate carrier-membrane configuration used in other membrane devices such as a plate-and-frame unit. These plate and frame devices are comprised of a leaf, or combination of leaves, that are stacked and may be separated by a small feed channel, and the feed channel may contain a feed spacer material. Accordingly, one or more improvements in a spiral wound membrane element described herein will lead to improvements in other membrane devices.

One or more features discussed above can be used in membrane devices and systems such as home reverse osmosis, tankless home reverse osmosis systems, industrial reverse osmosis systems, municipal applications, low pressure and ultra low pressure applications, the beverage industry, the pharmaceutical industry, the semiconductor industry, for dialysis applications, and for power applications. Some of these applications have standard sizes and requirements for membrane devices and the present teachings can provide for optimal usage within the required parameters.

For example, FIG. 2 shows a schematic representation of a home RO system 200 according to one embodiment. System 200 operates under a feed pressure which can vary between less than 40 psi to approximately 75 psi and is usually around 60 psi in the United States. System 200 includes a membrane element 202, which can be constructed using one or more of the embodiments discussed herein.

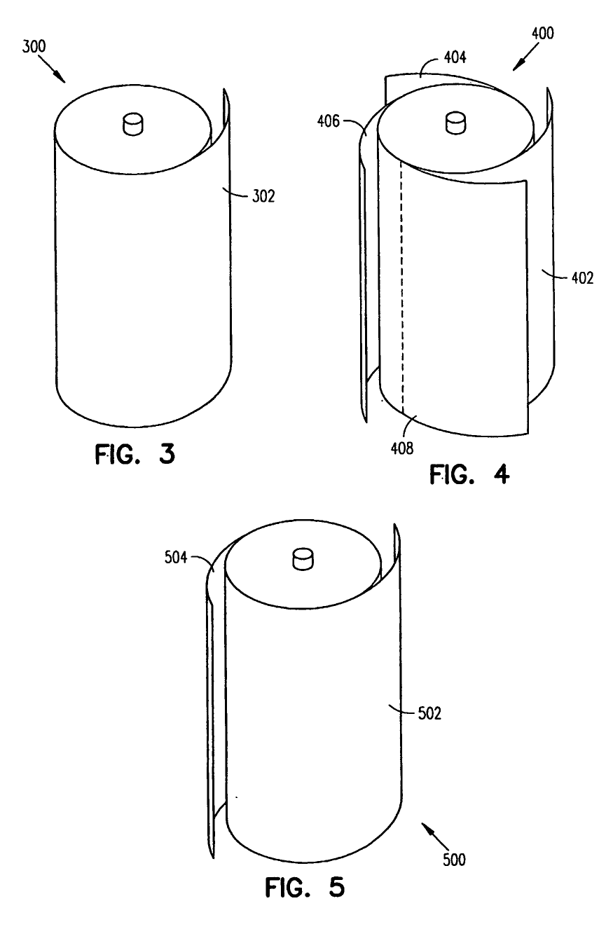

FIG. 3 shows a membrane element 300 according to one embodiment. Element 300 includes a spiral wound single leaf 302 design. In one embodiment, element 300 can have an outer diameter of approximately 2.0 inches or less and a length of approximately 12 inches or less. Using membranes and permeate carriers as discussed herein, element 300 can have a permeate flow rate of approximately 150 gpd or greater under 60 psi feed pressure.

FIG. 4 shows a membrane element 400 according to one embodiment. Membrane element includes two are more leafs 402, 404, 406, and 408 in a spiral wound configuration. In one embodiment, each leaf includes a membrane having an A value of 25 or greater, the total leaf surface area can be approximately 350 square feet or greater, each leaf has a leaf length of approximately 42 inches or greater. Element 400 can have a β value of 0.82 or greater. In some embodiments, element 400 has an outer diameter of approximately 8 inches or less.

In one embodiment, membrane element 400 can have a total leaf membrane surface area of approximately 60 to 125 square feet, the membranes can have an A-value of 25 or greater, and the element can have a β value of 0.82 or greater. In this example, element 400 can have an outer diameter of approximately 4 inches or less.

FIG. 5 shows a membrane element 500 according to one embodiment. Element 500 includes first and second spiral wound leafs 502 and 504. In one embodiment, each leaf 502 and 504 includes a membrane having an A value of 25 or greater, the leafs each have a length of 3.5 feet or less, the element has an 20 inch length or less, and the element has a β value of 0.75 or greater. In one embodiment, element 400 can have a outer diameter of 3.25 inches or less. In one embodiment, element 500 has an A value of approximately 30 to 40.

It is understood that the above description is intended to be illustrative, and not restrictive. Many other embodiments will be apparent to those of skill in the art upon reviewing the above description. The scope of the invention should, therefore, be determined with reference to the appended claims, along with the full scope of equivalents to which such claims are entitled.

1. A membrane device comprising:
a first membrane sheet and a second membrane sheet separated by a permeate carrier having an H-value of about 0.045 atm-sec/gm or less, wherein the membrane device is capable of at least 50% MgSO₄ rejection of 500 ppm MgSO₄ in DI water at 65 psi applied pressure at 10 cm/s average feed channel cross-flow velocity at 77 degrees F.

2. The device of claim 1, wherein the H-value is about 0.040 atm-sec/gm or less.

3. The device of claim 1, wherein the H-value is about 0.035 atm-sec/gm or less.

4. The device of claim 1 wherein the thickness of the permeate carrier is approximately 0.013 inches or less.

5. The device of claim 1 wherein the thickness of the permeate carrier is approximately 0.020 inches or less.

6. The device of claim 1 wherein the thickness of the permeate carrier is approximately 0.025 inches or less.

7. The device of claim 1 wherein the A value of each of the first membrane sheet and the second membrane sheet is approximately 15 or less.

8. The device of claim 1 wherein the A value of each of the first membrane sheet and the second membrane sheet is approximately 15-25.

9. The device of claim 1 wherein the A value of each of the first membrane sheet and the second membrane sheet is approximately 25-40.

10. The device of claim 1 wherein the A value of each of the first membrane sheet and the second membrane sheet is approximately 40 or greater.

11. The device of claim 1 wherein the A value of each of the first membrane sheet and the second membrane sheet is approximately 30.

12. The device of claim 1 wherein the first membrane sheet and the second membrane sheet define a leaf, wherein the leaf has a length of approximately 3 feet or less.

13. The device of claim 1 wherein the first membrane sheet and the second membrane sheet define a leaf, wherein the leaf has a length of approximately 3 feet to 5 feet.

14. The device of claim 1 wherein the first membrane sheet and the second membrane sheet define a leaf, wherein the leaf has a length of approximately 5 feet to 15 feet.

15. The device of claim 1 wherein the first membrane sheet and the second membrane sheet define a leaf, wherein the leaf has a length of approximately 15 feet or greater.

16. The device of claim 1 wherein the membrane device has ÿ value of approximately 0.98 or greater.

17. The device of claim 1 wherein the membrane device has ÿ value of approximately 0.95 to approximately 0.98.

18. The device of claim 1 wherein the membrane device has ÿ value of approximately 0.90 to approximately 0.95.

19. The device of claim 1 wherein the membrane device has ÿ value of approximately 0.85 to approximately 0.90.

20. The device of claim 1 wherein the membrane device has ÿ value of approximately 0.50 to approximately 0.85.

21. A membrane device comprising:
a first membrane sheet and a second membrane sheet separated by a permeate carrier having an H-value of 0.030 atm-sec/gm or less and a thickness of approximately 0.025 inches or less, wherein the membrane device is capable of at least 50% MgSO₄ rejection of 500 ppm MgSO₄ in DI water at 65 psi applied pressure at 10 cm/s average feed channel cross-flow velocity at 77 degrees F.

22. A membrane device comprising:
a first membrane sheet and a second membrane sheet separated by a permeate carrier having an H-value of 0.070 atm-sec/gm or less and a thickness of approximately 0.015 inches or less, wherein the membrane device is capable of at least 50% MgSO₄ rejection of 500 ppm MgSO₄ in DI water at 65 psi applied pressure at 10 cm/s average feed channel cross-flow velocity at 77 degrees F.

23. A membrane device comprising:
a first membrane sheet and a second membrane sheet separated by a permeate carrier having an H-value of 0.10 atm-sec/gm or less and a thickness of approximately 0.013 inches or less, wherein the membrane device is capable of at least 50% MgSO₄ rejection of 500 ppm MgSO₄ in DI water at 65 psi applied pressure at 10 cm/s average feed channel cross-flow velocity at 77 degrees F.

24. A membrane device comprising:
a first membrane sheet and a second membrane sheet separated by a permeate carrier having an H-value of 0.05 atm-sec/gm or less and a thickness of approximately 0.021 inches or less, wherein the membrane device is capable of at least 50% MgSO₄ rejection of 500 ppm MgSO₄ in DI water at 65 psi applied pressure at 10 cm/s average feed channel cross-flow velocity at 77 degrees F.

25. The device of claim 21 wherein the A value of each of the first membrane sheet and the second membrane sheet is approximately 15 or less.

26. The device of claim 21 wherein the A value of each of the first membrane sheet and the second membrane sheet is approximately 15-25.

27. The device of claim 21 wherein the A value of each of the first membrane sheet and the second membrane sheet is approximately 25-40.

28. The device of claim 21 wherein the A value of each of the first membrane sheet and the second membrane sheet is approximately 40-60.

29. The device of claim 21 wherein the A value of each of the first membrane sheet and the second membrane sheet is approximately 60 or greater.

30. The device of claim 21 wherein the first and second membranes define a leaf, wherein the leaf has a length of approximately 3 feet or less.

31. The device of claim 21 wherein the first and second membranes define a leaf, wherein the leaf has a length of approximately 3 feet to 5 feet.

32. The device of claim 21 wherein the first and second membranes define a leaf, wherein the leaf has a length of approximately 5 feet to 15 feet.

33. The device of claim 21 wherein the first and second membranes define a leaf, wherein the leaf has a length of approximately 15 feet or greater.

34. The device of claim 21 wherein the membrane device has ÿ value of approximately 0.98 or greater.

35. The device of claim 21 wherein the membrane device has ÿ value of approximately 0.95 to 0.98.

36. The device of claim 21 wherein the membrane device has ÿ value of approximately 0.90 to 0.95.

37. The device of claim 21 wherein the membrane device has ÿ value of approximately 0.85 to 0.90.

38. The device of claim 21 wherein the membrane device has ÿ value of approximately 0.50 to 0.85.

39. A home reverse osmosis system comprising:
a single leaf spiral wound membrane element which includes a first membrane sheet and a second membrane sheet separated by a permeate carrier, wherein the spiral wound membrane element has a diameter of approximately 2.0 inches or less and a length of approximately 12 inches or less, wherein the membrane element is adapted to have a permeate flow rate of at least 150 gallons per day when tested with 500 ppm NaCl in DI water at 65 psi applied pressure at 10 cm/s average feed channel cross-flow velocity at 77 degrees F.

40. The system of claim 39, wherein each of the membrane sheets has an A-value of approximately 25 or greater.

41. The system of claim 39 wherein a net driving pressure of the system is approximately 30 psi or less.

42. The system of claim 39, wherein the NaCl rejection of the device is at least 90% when tested with 500 ppm NaCl in DI water at 65 psi applied pressure at 10 cm/s average feed channel cross-flow velocity at 77 degrees F.

43. A tankless home reverse osmosis system comprising:
a membrane device including a single leaf structure which includes a first membrane and a second membrane separated by a permeate carrier, wherein the membrane device has a length of approximately 20 inches or less, each of the membranes has an A-value of approximately 25 or greater, wherein the membrane device has a ÿ value of at least about 0.60.

44. The system of claim 43, wherein the ÿ value is at least about 0.80.

45. The system of claim 43 wherein the device has a NaCl rejection of at least 90% when tested with 500 ppm NaCl in DI water at 65 psi at 10 cm/s average feed channel cross-flow velocity at 77 degrees F.

46. A high flow home reverse osmosis system comprising:
a membrane device including a single leaf structure which includes a first membrane and a second membrane-separated by a permeate carrier, wherein the membrane device has an outer diameter of approximately 2.0 inches or less and a length of approximately 12 inches or less, wherein the membrane device has a ÿ value of at least about 0.90 and an A value of approximately 25 or greater.

47. The system of claim 46, wherein the membrane device has a ÿ value of at least 0.95.

48. A membrane device comprising:
one or more leaves, each leaf including a first membrane sheet and a second membrane sheet separated by a permeate carrier, the one or more leaves having a total surface area of at least 350 square feet, wherein the element leaf length is greater than 42″, wherein each of the membrane sheets has an A-value of approximately 25 or greater; and
wherein the membrane element has a ÿ value of at least 0.82
wherein the membrane device is capable of at least 50% MgSO₄ rejection of 500 ppm MgSO₄ in DI water at 65 psi at 10 cm/s average feed channel cross-flow velocity at 77 degrees F.

49. The membrane device of claim 48, wherein the outer diameter of the membrane device is less than or equal to approximately 8 inches.

50. The membrane device of claim 48 wherein the length of each of the one or more leaves is approximately 5 feet or greater.

51. The membrane device of claim 48, wherein the membrane device has a ÿ value of at least 0.90.

52. The membrane device of claim 48, wherein each of the membrane sheets has an A-value of approximately 25-35.

53. The membrane device of claim 48, wherein each of the membrane sheets has an A-value of approximately 35-60.

54. The membrane device of claim 48, wherein each of the membrane sheets has an A-value of approximately 60 or greater.

55. The membrane device of claim 48, wherein the membrane device includes 16 or fewer leaves.

56. The membrane device of claim 48, wherein the membrane device includes 4 or fewer leaves.

57. A membrane device comprising:
one or more leaves, each leaf including a firsts membrane sheet and a second membrane sheet separated by a permeate carrier, the one or more leaves having a total surface area of between 60 to 125 square feet, wherein the element leaf length is greater than 42″, wherein each of the membrane sheets has an A-value of approximately 25 or greater; and
wherein the membrane element has a ÿ value of at least about 0.82
wherein the membrane device is capable of at least 50% MgSO₄ rejection of 500 ppm MgSO₄ in DI water at 65 psi at 10 cm/s average feed channel cross-flow velocity at 77 degrees F.

58. The membrane device of claim 57, wherein the outer diameter of the membrane element is less than or equal to approximately 4 inches.

59. The membrane device of claim 57 wherein the length of each of the one or more leaves is approximately 5 feet or greater.

60. The membrane device of claim 57 wherein the device includes one to four leaves.

61. The membrane device of claim 57, wherein the membrane element has a ÿ value of at least about 0.90.

62. The membrane device of claim 57, wherein each of the membrane sheets has an A-value of approximately 25-35.

63. The membrane device of claim 57, wherein each of the membrane sheets has an A-value of approximately 35-60.

64. The membrane device of claim 57, any of claim 57-61, wherein each of the membrane sheets has an A-value of approximately 60 or greater.

65. A membrane device comprising:
one or more leaves, each leaf including a pair of membrane sheets comprised of either two separate sheets or one sheet folded upon itself separated by a permeate carrier, the membrane element having an outer diameter greater than 8″, wherein the element leaf length is greater than 42″, wherein each of the membrane sheets has an A-value of approximately 25 or greater; and wherein the membrane element has a ÿ value of at least 0.82, wherein the membrane device is capable of at least 50% MgSO₄ rejection of 500 ppm MgSO₄ in DI water at 65 psi at 10 cm/s average feed channel cross-flow velocity at 77 degrees F.

66. The membrane device of claim 65 wherein the outer diameter of the element is greater than or equal to 12″.

67. The membrane device of claim 65 wherein the length of each of the one or more leaves is approximately 5 feet or greater.

68. The membrane device of claim 65, wherein the membrane element has a ÿ value of at least 0.90.

69. A membrane device including a single leaf structure which includes a pair of membrane sheets comprised of either two separate sheets or one sheet folded upon itself separated by a permeate carrier, wherein the membrane element has a length of approximately 20 inches or less, the membrane has an A-value of approximately 25 or greater, wherein the leaf length is at least 8 feet, wherein the membrane element has a ÿ value of at least 0.75.

70. A membrane element including a double leaf structure, each leaf including a pair of membrane sheets comprised of either two separate sheets or one sheet folded upon itself separated by a permeate carrier, wherein the membrane element has a length of approximately 20 inches or less, the membrane has an A-value of approximately 25 or greater, wherein each leaf length is at least 3.5 feet, wherein the membrane element has a ÿ value of at least 0.75.

71. The membrane element of claim 70, wherein the element includes a spiral wound configuration having an outer diameter of approximately 3.25 inches or less.

72. The membrane element of claim 70, wherein the salt retention of the membrane element is at least 90%.

73. The membrane element of claim 70, wherein the membrane sheets have an A-value of approximately 30 to 40.
